(19) United States
(12) Patent Application Publication
(10) Pub. No.: US 2004/0225482 A1
(43) Pub. Date: Nov. 11, 2004

(54) Design and evaluation of actively cooled turbine components

(76) Inventors: Dimitry S. Vladimirov, Daly City, CA (US); Maurice J. Bales, Lafayette, CA (US)

Correspondence Address: KUNZLER & ASSOCIATES, 8 EAST BROADWAY, SALT LAKE CITY, UT, 84111, US

(21) Appl. No.: 10/677,100

(22) Filed: Sep. 30, 2003

Related U.S. Application Data
(60) Provisional application No. 60/428,043, filed on Nov. 20, 2002.

(51) Int. Cl. G06F 17/10

(52) U.S. Cl. 703/2

(57) ABSTRACT

Embodiments in accordance with the present invention provide apparatus and methods for determining heat transfer characteristics of an actively cooled component, such as, but not limited to, a turbine blade.

### CROSS REFERENCE TO RELATED APPLICATION

The present application claims priority from Provisional Patent Application, AIRFOIL INTERNAL PASSAGE DESIGN FOR IMPROVED HEAT TRANSFER, Ser. No. 60/428,043, filed Nov. 20, 2002.

### FIELD OF THE INVENTION

The present invention relates to turbine blade design, and, more particularly, to methods and apparatus for determining thermal performance of actively cooled turbine components.

### BACKGROUND OF INVENTION

A turbine engine produces forward thrust by expelling high-energy gas from the rear of the engine. The turbine engine produces the high-energy gas by passing air through a compression stage to a combustion chamber where fuel is burned in the compressed air creating high-energy expanding gas that passes though a turbine stage and out of the engine. The expanding gas causes rotation of the turbine stage that drives the rotation of the compression stage, which share a common shaft on the axis of rotation. The turbine stage comprises one or more turbines. Each turbine comprises a plurality of spaced-apart turbine blades extending radially from a central turbine ring. The blades have an airfoil profile and are positioned at an angle of attack to the incoming flow of air.

FIG. 1 is a front view of a representation of a turbine stage 40 comprising the turbine blades 42 and turbine 44. FIG. 2 is a partial side view of the turbine stage 40 showing generally the profile of the turbine blades 42 in the shape of an airfoil. The combustion gas 41 flows through the turbine stage 40, passing around the turbine blades 42 coupled to the turbine ring 44. The passing gas 41 causes a lifting force on each turbine blade 42, which causes the turbine stage 40 to rotate about a central shaft 46.

Turbine engine performance is directly related to the level of energy of the expanding gas in the combustion chamber. Consequently, to achieve high energy, the gas is raised to an extremely high temperature by the heat of combustion. Combustion gas temperature of modern turbine engines can exceed the melt temperature of the material of which the turbine blade is made. To prevent the turbine blades from failing, the turbine blades are kept below the melt temperature by the flow of cooling fluid passing through fluid passages within the internal structure of the turbine blade. This process is referred to as active cooling.

The cooling effect on the turbine blades by the cooling fluid must be carefully balanced with the need to maintain the high energies, and therefore the high temperature, of the combustion gas. To achieve high efficiency, the turbine blades must be cooled enough to keep them from failing, but not cooled enough to significantly lower the temperature of the expanding gas. In practice, the balance between the turbine blade temperature and gas temperature is very narrow to achieve high efficiency and low failure.

The fluid passages within a turbine blade are designed considering the heat transfer between the turbine blade and the gas. The heat transfer has been attempted to be measured or predicted using a number of techniques, including airflow testing, testing during engine operation, and predictive numerical modeling. The quality of the data generated by measuring or numerical prediction techniques depends strongly on the quality of the measurements and the sophistication of the numerical methods. Further, numerical methods are validated using experimental data, going back to the need for quality measurements.

The leading edge of the turbine blade is first to come into contact with the flow of hot gas when the hot gas is at its greatest temperature and greatest mass flow rate. The leading edge, therefore, presents the greatest heat transfer condition as compared with other areas of the turbine blade. The heat transfer can be determined at points over the surface of the turbine blade to create a heat transfer map based on measured or predicted surface temperature.

The goal of the designer is to produce a uniform thermal profile across the turbine blade outer surface at a low enough temperature to keep the turbine blade from failing, but high enough to maintain good engine efficiency. Whether designers rely on numerical models to simulate turbine blade thermal performance or they rely on measurements during testing, the critical factor for accurate design is the accurate determination of the heat transfer characteristics of the actively cooled turbine blade.

### BRIEF DESCRIPTION OF THE DRAWINGS

FIG. 1 is a front view of a representation of a turbine stage comprising the turbine blades and turbine ring;

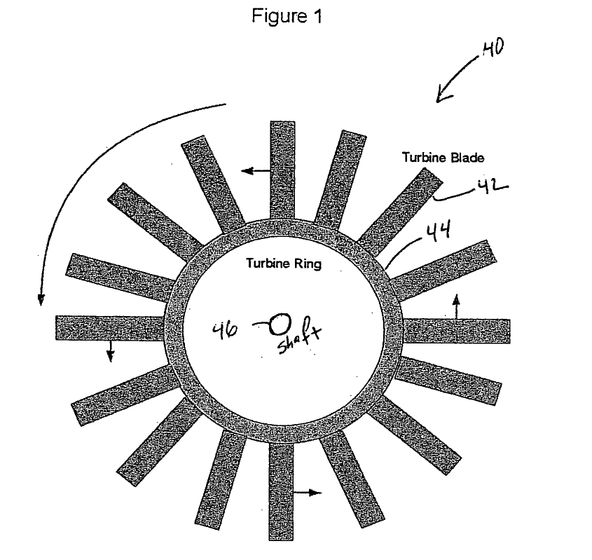

FIG. 2 is a partial side view of the turbine stage showing generally the profile of the turbine blades in the shape of an airfoil.

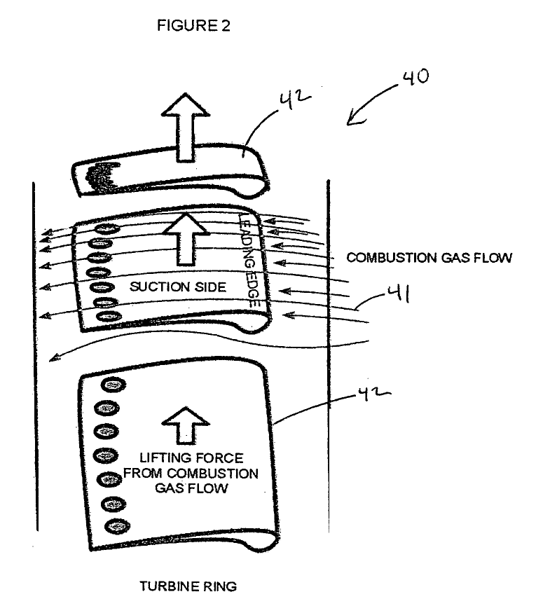

FIG. 3 is a flow diagram of an embodiment of the method in accordance with the present invention;

FIG. 4 is a partial cross-sectional view of a wall between an internal cooling passage and the exterior surface of a component; and

FIG. 5 illustrates a thermal imaging apparatus suitable for use to practice the invention, in accordance with one embodiment on the invention.

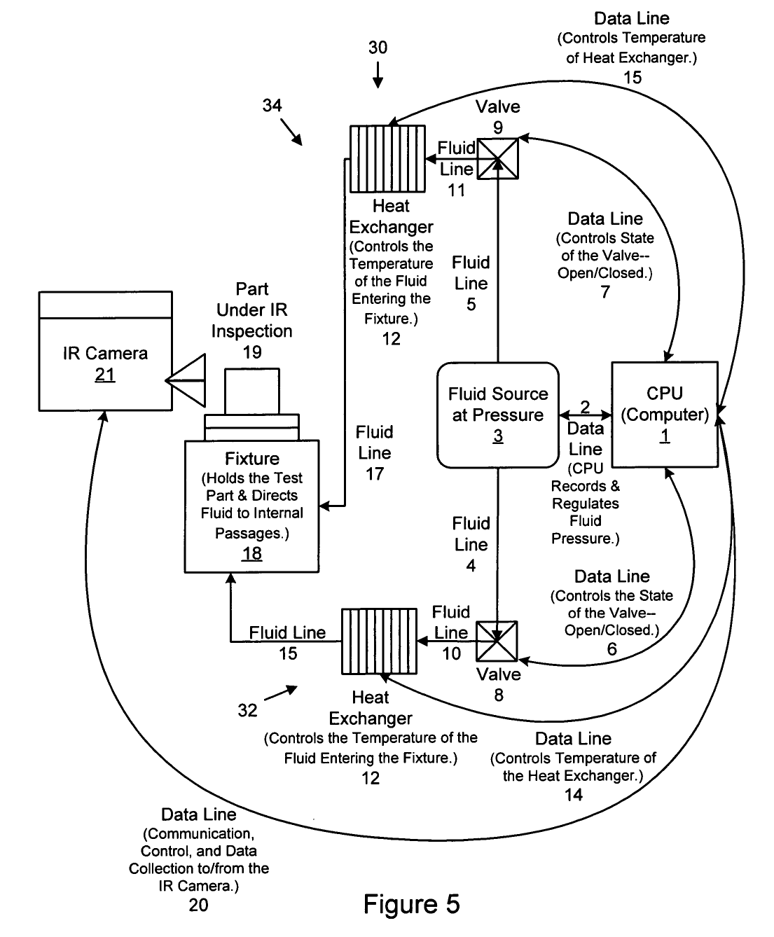

### DESCRIPTION

In the following detailed description, reference is made to the accompanying drawings which form a part hereof wherein like numerals designate like parts throughout, and in which is shown by way of illustration specific embodiments in which the invention may be practiced. It is to be understood that other embodiments may be utilized and structural or logical changes may be made without departing from the scope of the present invention. Therefore, the following detailed description is not to be taken in a limiting sense, and the scope of the present invention is defined by the appended claims and their equivalents.

Embodiments in accordance with the present invention provide apparatus and methods for determining heat transfer characteristics of an actively cooled component, such as, but not limited to, a turbine blade. Once the heat transfer characteristics of an actively cooled component is determined, the component can be optimize for thermal performance.

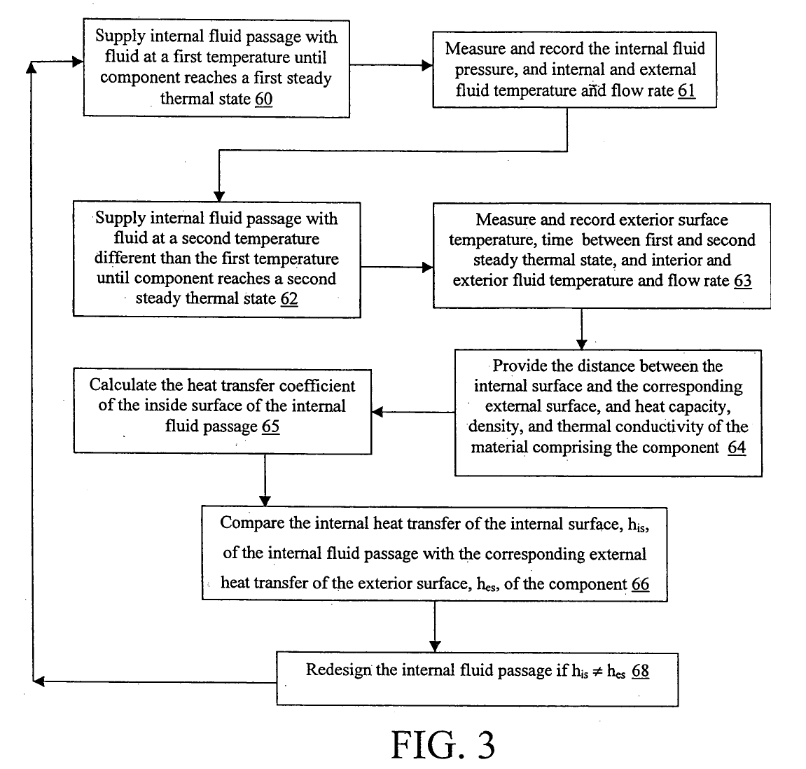

FIG. 3 is a flow diagram of an embodiment of the method in accordance with the present invention. The internal fluid passage of a component is supplied with a fluid at a first temperature until the component reaches a first steady thermal state 60. The internal fluid pressure and internal and external fluid temperature and flow rate are measured and recorded 61.

Next, the internal fluid passage of the component is supplied with a fluid at a second temperature until the component reaches a second steady thermal state 62. The exterior surface temperature, time between first and second steady thermal state, and internal and external fluid temperature and flow rate are measured and recorded 63.

Then, the distance between the internal surface and the corresponding external surface, and heat capacity, density, and thermal conductivity of the material comprising the component are provided. Based on these data provided, the heat transfer coefficient of the internal surface of the internal fluid passage is calculated 65.

The internal heat transfer of the internal surface of the internal fluid passage is compared with the corresponding external heat transfer of the exterior surface of the component 66. If the internal heat transfer of the internal surface does not equal the external heat transfer of the exterior surface, the internal fluid passage is re-designed 68.

After re-design, the thermal performance of the component is re-re-evaluated by repeating the earlier described process or portions thereof.

In another embodiment, a flow of hot gas is established passing through the cooling passages of the turbine blade. A hot gas is used in this embodiment, although in other embodiments, a cold gas or other fluid with known thermal and fluid properties with a temperature difference as compared with the turbine blade, may be used instead.

In any event, the fluid imparts a thermal gradient, and therefore a heat transfer, between the inside surface of the cooling passage and the outer surface of the turbine blade. A thermal imaging system, such as one comprising an infrared camera, images the external surface during a thermal cycle to measure the dynamic surface temperature of the component over the course of the thermal cycle.

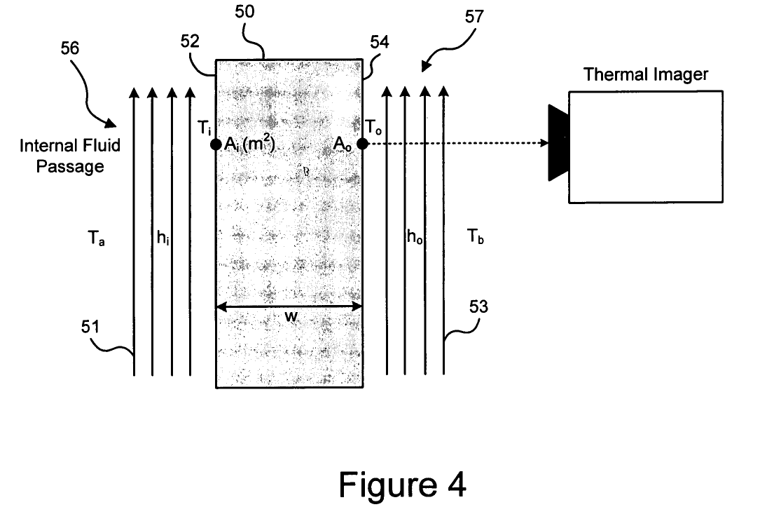

The internal heat transfer is derived from the measurement of the external surface temperature in accordance with the following mathematical approach. Nomenclature is defined as presented in FIG. 4 and below:

Tₐ=the temperature of the internal fluid 51 within the internal fluid passage 56 at point i and of a small arbitrary area Aᵢ through which a tangent line to the internal surface 52 of the internal fluid passage 56 passes. This value is known from direct measurement of the incoming fluid. Tₐ is measured in degrees Kelvin, or (K). Aᵢ is measured in meters\hat{2}, or (m\hat{2}) and is defined as the smallest discernable area, or resolution, that can be measured by the thermal imager.

hᵢ=the internal heat transfer coefficient at the internal surface 52 of the internal fluid passage 56 at a small area Aᵢ through which the same line referenced in the definition of Tₐ passes. This value is unknown and solved for in the following relationship, and is measured in Watts/K*m\hat{2}, or (W/K*m).

Tᵢ=the internal temperature at the internal surface 52 of the internal fluid passage 56 at the same small area Aᵢ referenced in the definition of hᵢ, measured in (K).

Tₒ=the external temperature of the component 50 at a point o and of a small area Aₒ through which the same line referenced in the definition of Tₐ passes, as measured by the thermal imaging system at some time t_{imaged} during the test t₀, or zero time. Tₒ is measured in (K,) t_{imaged}, and t₀ is measured in seconds, or (s).

w=the distance between points i and o, or the internal surface 52 and external surface 54 of the component 50 (wall thickness), through the line tangent to Aᵢ and the outer surface 54 of the component 50, measured in (m.).

V=the volume defined by Aᵢ*w, measured in (m\hat{3}).

E=the energy stored in the volume V around the line drawn referenced in the definition of Tₐ after the time tₜₑₛₜ, measured in Joules, or (J).

E_{conduction}=the energy imparted to the component 50 due to conduction, as conducted through the small volume V, measured in (J).

E_{convection}=the energy imparted to the component 50 at the area Aᵢ by the internal fluid 51 through convection, measured in J. Because there is only once source of energy, the internal fluid 51, E_{convection}=E_{conduction}=E.

Cₚ=the heat capacity of the material of the component, measured in (J/kg*K).

p=the density of the material comprising the component 50, measured in (kg/m\hat{3}).

k=the thermal conductivity of the material comprising the component 50, as measured by (W/m*K).

hₒ=the external heat transfer of the external surface 54 at a small area Aₒ through which the same line referenced in the definition of Tₐ passes. This value is measured in (W/K*m.). Where there is no external flow 53, hₒ is zero.

T_{b}=the temperature of the external fluid 53, measured in K. Where there is no external fluid 53, the temperature value does not impart an energy transfer to the external surface 54.

The Tₒ is measured at the external surface 54 by the thermal imaging system, therefore allowing E_{conduction}, or E, to be defined:

E_{conduction}=E=k*Aᵢ*t_{imaged}*(Tᵢ−Tₒ)/w (1)

The energy stored at the time of image capture by the thermal imaging system, or t_{imaged}, is defined by:

E=(Tᵢ−Tₒ)*Cₚ*p*V (2)

Also, on the small area Aᵢ of the interior surface 52, the energy E_{convection}, or E, is also defined:

E_{convection}=E=hᵢ*Aᵢ*t_{imaged}*(Tₐ−Tᵢ) (3)

There are only three unknown values: E, Tᵢ, and hᵢ.

Tᵢ is found by equating (1) and (2) and inputting known or calculated values for the thermal conductivity, area, time, wall thickness w, thermal capacity, density, volume, and surface temperature:

(k*Aᵢ* tₜₑₛₜ/w)*Tᵢ−Cₚ*p*V*Tᵢ=(k*Aᵢ*tₜₑₛₜ/w)*Tₒ−Cₚ*p*V*Tₒ (4)

The newly acquired value for Tᵢ can then be placed into equation (3), substituting E for the value obtained in equation (2), thereby solving for the internal heat transfer coefficient, hᵢ:

hᵢ=(Tᵢ−Tₒ)*Cₚ*p*V]/[Aᵢ*t_{imaged}*(Tₐ−Tᵢ)] (5)

This method can be used to calculate the heat transfer at all areas Aᵢ on all internal surfaces 52 whose tangent areas Aₒ of the external surface 54 are in the field of view of the thermal imaging system during a thermal stress cycle. Embodiments of methods for obtaining data from the thermal imaging system are provided below.

There are various ways to calculate the internal heat transfer coefficient, hᵢ, and those skilled in applying laws of thermodynamics will appreciate those methods. One such method in accordance with another embodiment of the invention, for example, but not limited thereto, is to introduce a flow of external fluid 53 to the external surface 54 with a known heat transfer coefficient hₒ and a known steady temperature T_{b}.

In such a method, a steady flow of internal fluid 51 and steady flow of external fluid 53 would eliminate any time dependencies measurable time intervals such as t_{imaged} of a brief transient flow, and the power distributed through the system, q would be calculated rather than energies E, to determine hᵢ:

[q/(hᵢ*Aᵢ)]+[q*w/(k*Aᵢ)]+[q/(hₒ*Aᵢ)]=Tₐ−T_{b} (6)

With q being defined by the equation:

q=hₒ*Aᵢ*(T₂−T_{b}) (7)

Once the internal heat transfer coefficient, hᵢ, of the internal surface 52 is quantified, this value can be augmented by re-design of the internal fluid passage 56. The internal fluid passage 56 can be re-designed to affect the internal heat transfer coefficient, hᵢ, in a desired way, including such features and/or parameters as, but not limited to, increasing or decreasing the dimensions of the internal fluid passage 56, adding or removing barriers that disrupt or induce turbulence in the flow, re-positioning the internal fluid passages 56, and adding or removing internal fluid passages 56.

The re-designed component would then be evaluated again using the thermal imaging system in accordance with the embodiments of the methods described above. A final desired solution may require multiple iterations of thermal imaging and re-design of the component.

The desired final solution for the internal heat transfer coefficient, hᵢ, depends on the application of the actively cooled component.

In one embodiment in accordance with the present invention, the desired final solution for an actively cooled turbine blade would be a design that produces an internal heat transfer from the interior fluid 51 that matches the external heat transfer to the turbine blade from the exterior fluid 53, in this case combustion gas. This final solution would yield efficient engine operating performance.

In accordance with an embodiment of the present invention, a thermographer is provided that is adapted to thermally stress a component having an internal fluid passage, such as a cooling passage of a turbine component, to measure and determine the thermal properties of the component under dynamic thermal loading conditions. In use, the thermographer causes a fluid of predetermined temperature to pass through the internal fluid passage. The surface temperature of the component is measured and recorded using an appropriate device, such as, but not limited to, a thermal imaging system. The resulting data, in one embodiment, are used to quantify the component's internal heat transfer coefficient.

The thermographer comprises a fluid system 30, a thermal imaging system 21, and a computer-based control system 1. The fluid system 30 comprises a pressurized fluid vessel 3, a first fluid supply line 4 and a second fluid supply line 16 both in fluid communication with the fluid vessel 3, and a test fixture 18. The first fluid supply line 32 comprises a first vessel fluid line 4 in fluid communication with the vessel 3, a first control valve 8 in fluid communication with the first vessel fluid line 4, a first valve fluid line 10 in fluid communication with the first control valve 8, a first heat exchanger 12 in fluid communication with the first valve fluid line 10, a first heat exchanger fluid line 16 in fluid communication with the first heat exchanger 12, with the test fixture 18 in fluid communication with the first heat exchanger fluid line 16.

Similarly, the second fluid supply line 34 comprises a second vessel fluid line 5 in fluid communication with the vessel 3, a second control valve 9 in fluid communication with the second vessel fluid line 5, a second valve fluid line 11 in fluid communication with the second control valve 9, a second heat exchanger 13 in fluid communication with the second valve fluid line 11, a second heat exchanger fluid line 17 in fluid communication with the second heat exchanger 13, with the test fixture 18 in fluid communication with the second heat exchanger fluid line 17.

The thermal imaging system 21 comprises components, such as, but not limited to, one or more infrared cameras, adapted to visualize and measure the dynamic surface temperature encountered during the evaluation.

The computer-based control system 1 comprises a central processing unit, with corresponding data lines in electrical communication with the various components of the thermographer 30. The control system 1 is adapted to control and record the fluid pressure within the vessel 3 through the pressure vessel data line 2; control the first and second heat exchangers 12, 13 to control and record the temperature of the fluid through the first and second heat exchanger data lines 14, 15, respectively; control the first and second control valves 8, 9 to regulate the flow of fluid to the test fixture 18 through first and second control valve data lines 6, 7, respectively; and control and record data from the thermal imaging system 21 through the thermal imaging system data line 20.

The control system 1 is adapted to communicate a signal through the first valve data line 6 to control the first control valve 8 to regulate the release of a predetermined amount of fluid from the pressurized fluid vessel 3 through the first vessel fluid line 4. The fluid passes through the first control valve 8 and the first valve fluid line 10 to the first heat exchanger 12. The first heat exchanger 12 is adapted to provide the fluid with a predetermined temperature controlled by the control system 1 via the first heat exchanger data line 14. The first heat exchanger 12 is adapted to heat the fluid to an elevated temperature, such as, but not limited to, 450 C, and supply the test fixture 18 with the fluid through the first heat exchanger fluid line 16.

The control system 1 is adapted to communicate a signal through the second valve data line 7 to control the second control valve 9 to regulate the release of a predetermined amount of fluid from the pressurized fluid vessel 3 through the second vessel fluid line 5. The fluid passes through the second control valve 9 and the second valve fluid line 11 to the second heat exchanger 13. The second heat exchanger 13 is adapted to provide the fluid with a predetermined temperature controlled by the control system 1 via the second heat exchanger data line 15. The second heat exchanger 13 is adapted to provide the fluid with a desired temperature, and supply the test fixture 18 with the fluid through the second heat exchanger fluid line 17.

In accordance with an embodiment of the method of the present invention, the thermographer 30 is used to test and record thermal performance data of an actively cooled component, such as a turbine blade, having an internal fluid passage. An actively cooled component 19 is mounted on the test fixture 18 such that the internal fluid passage 56 within the component 19 is in fluid communication with the fluid supplied by the first heat exchanger fluid line 16 as well as the second heat exchanger fluid line 17. The actively cooled component 19 is mounted such that the surface of interest is in view of the IR camera 21.

The control system 1 controls and records the fluid pressure in the pressurized vessel 3 and communicates a signal to open the first control valve 8. The fluid passes through the first control valve 8 and through the first control valve fluid line 10 to the first heat exchanger 12. The first heat exchanger 12 provides a hot fluid having a predetermined temperature, which is supplied to the internal fluid passage 56 of the component 19.

After the component 19 reaches a steady-state thermal condition from the hot fluid from the first heat exchanger 12, the control system 1 communicates a signal to close the first control valve 8 and open the second control valve 9. Fluid passes from the vessel 3 through the second control valve 9 and through the second control valve fluid line 11 to the second heat exchanger 13. The second heat exchanger 13 provides a cold fluid with a predetermined temperature lower than that of the hot fluid provided by the first heat exchanger 13, such as, but not limited to, a temperature 50 C lower. The cold fluid is supplied to the internal fluid passage 56 of the component 19.

The cold fluid acts as a “cold” source, which cools the component 19 from the previously heated state. After the component 19 reaches a steady-state thermal condition from the cold fluid from the second heat exchanger 13, the control system 1 communicates a signal to close the second control valve 9, completing a cycle of the test.

During the test cycle, the control system 1 sends a signal via the thermal imaging system data line 20 to the thermal imaging system 21 to control the IR camera 22. The IR camera 22 detects and records thermal images, or surface temperature profile maps, at predetermined times during the cool-down phase of the test cycle, to record the change in temperature of the surface of interest on the component 19. The IR camera 22 collects the data and communicates the information via the thermal imaging system data line 20 to the control system 1 for recording and processing.

FIG. 6 illustrates an example computer system suitable for use to practice the present invention, in accordance with one embodiment. As shown, computer system 600 includes one or more processors 602, and system memory 604. Additionally, computer system 600 includes mass storage devices 606 (such as diskette, hard drive, CDROM and so forth), input/output devices 608 (such as keyboard, cursor control and so forth) and communication interfaces 610 (such as network interface cards, modems and so forth). The elements are coupled to each other via system bus 612, which represents one or more buses. In the case of multiple buses, they are bridged by one or more bus bridges (not shown).

Each of these elements performs its conventional functions known in the art. In particular, system memory 604 and mass storage 606 may employed to store a working copy and a permanent copy of the programming instructions implementing the computational logic 622 to practice the present invention. Computational logic 622 may be implemented in assembler instructions supported by processor(s) 602 or high level languages, such as C, that can be compiled into such instructions. The permanent copy of the programming instructions may be loaded into mass storage 606 in the factory, or in the field, through e.g. a distribution medium (not shown) or through communication interface 610 (from a distribution server (not shown)).

The constitution of these elements 602-612 are known, and accordingly will not be further described.

In embodiments in accordance with the present invention, a design of the internal passages of an actively cooled turbine component may be evaluated.

It is understood that embodiments of the present invention may be practiced using a number of techniques for determining the surface temperature of the component. It is further understood that embodiments of the present invention may be practiced using a number of techniques for determining the internal heat transfer coefficient of the component. Variations of embodiments in accordance with the present invention achieve the same or similar result for the purpose of thermally stressing a turbine component via hot and cold fluids, internal or internal and external flow, and recording the temperature at the surface using a thermal imaging system for the purpose of evaluating actively cooled components to quantify the internal heat transfer coefficients.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiment shown and described without departing from the scope of the present invention. Those with skill in the art will readily appreciate that the present invention may be implemented in a very wide variety of embodiments. This application is intended to cover any adaptations or variations of the embodiments discussed herein. Therefore, it is manifestly intended that this invention be limited only by the claims and the equivalents thereof.

What is claimed is:

1. A method for designing an actively cooled turbine blade having an internal fluid passage, comprising:
determining interior heat transfer at an interior area of an interior surface of the fluid passage;
determining external heat transfer at an exterior area of an exterior surface adjacent the interior area;
comparing the internal and external heat transfer; and
redesigning and reevaluating the design of the interior fluid passage until the internal and external heat transfer are equal.

2. The method of claim 1, wherein determining comprises:
supplying the internal fluid passage with a fluid at a first temperature until the turbine blade reaches a first steady thermal state;
measuring and recording the internal fluid pressure and internal and external fluid temperature and flow rate;
supplying the internal fluid passage with a fluid at a second temperature until the turbine blade reaches a second steady thermal state; and
measuring and recording the exterior surface temperature, time between first and second steady thermal state, and internal and external fluid temperature and flow rate.

3. The method of claim 1, wherein the method further comprises
providing a distance between the internal surface and the corresponding external surface, and heat capacity, density, and thermal conductivity of the material comprising the component and
calculating a heat transfer coefficient of the internal surface of the internal fluid passage.

4. The method of claim 3, wherein said calculating of a heat transfer coefficient of the internal surface of the internal fluid passage comprises:
calculating a heat transfer coefficient of the internal surface of the internal fluid passage using the following equations:
hᵢ=(Tᵢ−Tₒ)*Cₚ*p*V]/[Aᵢ*t_{imaged}*(Tₐ−Tᵢ)]
where: Tₐ=temperature of the internal fluid at point i and of a small arbitrary area Aᵢ through which a tangent line to the internal surface of the internal passage passes;
hᵢ=an internal heat transfer coefficient at the internal surface of the internal passage at area Aᵢ through which the same line referenced in the definition of Tₐ passes;
Tᵢ=an internal temperature at the internal surface of the internal passage at area Aₗ;
Tₒ=an external temperature of the component at a point o and of a small area Aₒ through which the same line referenced in the definition of Tₐ passes, as measured at some time t_{imaged} during the test t₀, or zero time;
w=a distance between points i and o, or the internal surface and external surface of the component (wall thickness), through the line tangent to Aᵢ and the outer surface of the component;
V=a volume defined by Aᵢ*w, measured in (m\hat{3});
E=the energy stored in the volume V around the line drawn referenced in the definition of Tₐ after the time tₜₑₛₜ, measured in Joules, or (J);
E_{conduction}=energy imparted to the component due to conduction, as conducted through the small volume V;
E_{convection}=energy imparted to the component at the area Aᵢ by the internal fluid through convection;
Cₚ=heat capacity of the material of the component;
p=density of the material comprising the component; k=the thermal conductivity of the material comprising the component;
hₒ=external heat transfer of the external surface at area Aₒ; and
T_{b}=temperature of the external fluid, wherein: E_{conduction}, or E, is defined by E_{conduction}=E=k*Aᵢ*t_{imaged}*(Tᵢ−Tₒ)/w.

5. A method for optimizing the performance of a turbine engine, comprising:
determining a heat transfer coefficient of an internal surface of an internal fluid passage of a turbine blade; and
balancing heat transfer between the internal surface of the internal fluid passage and the internal fluid with an external surface of the turbine blade and an external fluid.

6. The method of claim 5, wherein said determining comprises:
supplying the internal fluid passage with a fluid at a first temperature until the turbine blade reaches a first steady thermal state;
measuring and recording the internal fluid pressure and internal and external fluid temperature and flow rate;
supplying the internal fluid passage with a fluid at a second temperature until the turbine blade reaches a second steady thermal state;
measuring and recording the exterior surface temperature, time between first and second steady thermal state, and internal and external fluid temperature and flow rate.

7. The method of claim 5, wherein the method further comprises providing a distance between the internal surface and the corresponding external surface, and heat capacity, density, and thermal conductivity of the material comprising the component and
calculating a heat transfer coefficient of the internal surface of the internal fluid passage.

8. The method of claim 7, wherein said calculating of a heat transfer coefficient of the internal surface of the internal fluid passage comprises:
calculating a heat transfer coefficient of the internal surface of the internal fluid passage using the following equations:
hᵢ=(Tᵢ−Tₒ)*Cₚ*p*V]/[Aᵢ*t_{imaged}*(Tₐ−Tᵢ)]
where: Tₐ=temperature of the internal fluid at point i and of a small arbitrary area Aᵢ through which a tangent line to the internal surface of the internal passage passes;
hᵢ=an internal heat transfer coefficient at the internal surface of the internal passage at area Aᵢ through which the same line referenced in the definition of Tₐ passes;
Tᵢ=an internal temperature at the internal surface of the internal passage at area Aₗ;
Tₒ=an external temperature of the component at a point o and of a small area Aₒ through which the same line referenced in the definition of Tₐ passes, as measured at some time t_{imaged} during the test t₀, or zero time;
w=a distance between points i and o, or the internal surface and external surface of the component (wall thickness), through the line tangent to Aᵢ and the outer surface of the component;
V=a volume defined by Aᵢ*w, measured in (m\hat{3});
E=the energy stored in the volume V around the line drawn referenced in the definition of Tₐ after the time tₜₑₛₜ, measured in Joules, or (J);
E_{conduction}=energy imparted to the component due to conduction, as conducted through the small volume V;
E_{convection}=energy imparted to the component at the area Aᵢ by the internal fluid through convection;
Cₚ=heat capacity of the material of the component;
p=density of the material comprising the component; k=the thermal conductivity of the material comprising the component;
hₒ=external heat transfer of the external surface at area Aₒ; and
T_{b}=temperature of the external fluid, wherein: E_{conduction}, or E, is defined by E_{conduction}=E=k*Aᵢ*t_{imaged}*(Tᵢ−Tₒ)/w.

9. An apparatus comprising:
a storage medium comprising a plurality of programming instructions to enable a designer to use the apparatus to
determine interior heat transfer at an interior area of an interior surface of an internal fluid passage of an actively cooled turbine blade, based at least in part on thermal data collected for the turbine blade;
determine external heat transfer at an exterior area of an exterior surface adjacent the interior area; and
compare the internal and external heat transfer to determine if they are equal; and
at least one processor coupled to the storage medium to execute the programming instructions.

10. The apparatus of claim 9, wherein the apparatus further comprise a thermal imager equipped to allow the designer to
supply the internal fluid passage with a fluid at a first temperature until the turbine blade reaches a first steady thermal state;
measure and record the internal fluid pressure and internal and external fluid temperature and flow rate;
supply the internal fluid passage with a fluid at a second temperature until the turbine blade reaches a second steady thermal state; and
measure and record the exterior surface temperature, time between first and second steady thermal state, and internal and external fluid temperature and flow rate.

11. The apparatus of claim 9, wherein the programming instructions further enable the designer to provide a distance between the internal surface and the corresponding external surface, and heat capacity, density, and thermal conductivity of the material comprising the component and calculate a heat transfer coefficient of the internal surface of the internal fluid passage.

12. The apparatus of claim 11, wherein the programming instructions are designed to calculate, as part of said calculating,
hᵢ=(Tᵢ−Tₒ)*Cₚ*p*V]/[Aᵢ*t_{imaged}*(Tₐ−Tᵢ)]
where: Tₐ=temperature of the internal fluid at point i and of a small arbitrary area Aᵢ through which a tangent line to the internal surface of the internal passage passes;
hᵢ=an internal heat transfer coefficient at the internal surface of the internal passage at area Aᵢ through which the same line referenced in the definition of Tₐ passes;
Tᵢ=an internal temperature at the internal surface of the internal passage at area Aₗ;
Tₒ=an external temperature of the component at a point o and of a small area Aₒ through which the same line referenced in the definition of Tₐ passes, as measured at some time t_{imaged} during the test t₀, or zero time;
w=a distance between points i and o, or the internal surface and external surface of the component (wall thickness), through the line tangent to Aᵢ and the outer surface of the component;
V=a volume defined by Aᵢ*w, measured in (m\hat{3});
E=the energy stored in the volume V around the line drawn referenced in the definition of Tₐ after the time tₜₑₛₜ, measured in Joules, or (J);
E_{conduction}=energy imparted to the component due to conduction, as conducted through the small volume V;
E_{convection}=energy imparted to the component at the area Aᵢ by the internal fluid through convection;
Cₚ=heat capacity of the material of the component;
p=density of the material comprising the component; k=the thermal conductivity of the material comprising the component;
hₒ=external heat transfer of the external surface at area Aₒ; and
T_{b}=temperature of the external fluid, wherein: E_{conduction}, or E, is defined by E_{conduction}=E=k*Aᵢ*t_{imaged}*(Tᵢ−Tₒ)/w.

13. An apparatus comprising
a storage medium having stored therein a plurality of programming instructions to enable a designer to
determine a heat transfer coefficient of an internal surface of an internal fluid passage of a turbine blade; and
balance the heat transfer between the internal surface of the fluid passage and the internal fluid with an external surface of the turbine blade and an external fluid; and
at least one processor coupled to the storage medium to execute the programming instructions.

14. The apparatus of claim 13, wherein the apparatus further comprises a thermal imager equipped to enable the designer to
supply the internal fluid passage with a fluid at a first temperature until the turbine blade reaches a first steady thermal state;
measure and record the internal fluid pressure and internal and external fluid temperature and flow rate;
supply the internal fluid passage with a fluid at a second temperature until the turbine blade reaches a second steady thermal state;
measure and record the exterior surface temperature, time between first and second steady thermal state, and internal and external fluid temperature and flow rate.

15. The apparatus of claim 13, wherein the programming instructions further enable the designer to provide a distance between the internal surface and the corresponding external surface, and heat capacity, density, and thermal conductivity of the material comprising the component and calculate a heat transfer coefficient of the internal surface of the internal fluid passage.

16. The apparatus of claim 15, wherein the programming instructions are designed to calculate, as part of said calculating,
hᵢ=(Tᵢ−Tₒ)*Cₚ*p*V]/[Aᵢ*t_{imaged}*(Tₐ−Tᵢ)]
where: Tₐ=temperature of the internal fluid at point i and of a small arbitrary area Aᵢ through which a tangent line to the internal surface of the internal passage passes;
hᵢ=an internal heat transfer coefficient at the internal surface of the internal passage at area Aᵢ through which the same line referenced in the definition of Tₐ passes;
Tᵢ=an internal temperature at the internal surface of the internal passage at area Aₗ;
Tₒ=an external temperature of the component at a point o and of a small area Aₒ through which the same line referenced in the definition of Tₐ passes, as measured at some time t_{imaged} during the test t₀, or zero time;
w=a distance between points i and o, or the internal surface and external surface of the component (wall thickness), through the line tangent to Aᵢ and the outer surface of the component;
V=a volume defined by Aᵢ*w, measured in (m\hat{3});
E=the energy stored in the volume V around the line drawn referenced in the definition of Tₐ after the time tₜₑₛₜ, measured in Joules, or (J);
E_{conduction}=energy imparted to the component due to conduction, as conducted through the small volume V;
E_{convection}=energy imparted to the component at the area Aᵢ by the internal fluid through convection;
Cₚ=heat capacity of the material of the component;
p=density of the material comprising the component; k=the thermal conductivity of the material comprising the component;
hₒ=external heat transfer of the external surface at area Aₒ; and
T_{b}=temperature of the external fluid, wherein: E_{conduction}, or E, is defined by E_{conduction}=E=k*Aᵢ*t_{imaged}*(Tᵢ−Tₒ)/w.
